(19) United States
(12) Patent Application Publication
(10) Pub. No.: US 2018/0063463 A1
(43) Pub. Date: Mar. 1, 2018

(54) BROADCAST SIGNAL RECEIVING APPARATUS AND CONTROL METHOD THEREOF

(71) Applicant: SAMSUNG ELECTRONICS CO., LTD., Suwon-si (KR)

(72) Inventor: Chang-hyo KIM, Seoul (KR)

(73) Assignee: SAMSUNG ELECTRONICS CO., LTD., Suwon-si (KR)

(21) Appl. No.: 15/680,567

(22) Filed: Aug. 18, 2017

(30) Foreign Application Priority Data
Aug. 30, 2016 (KR) 10-2016-0111166

(51) Int. Cl. H04N 5/50; H04N 5/44; H01Q 1/24; H04N 7/20

(52) U.S. Cl. CPC H04N 5/50; H04N 5/4403; H04N 2005/4408; H04N 7/20; H04N 2005/4412; H01Q 1/247

(57) ABSTRACT

A broadcast signal receiving apparatus includes a connector configured to connect the apparatus to an antenna; a tuner configured to output a control signal to the antenna via the connector such that the antenna tunes a broadcast signal based on the control signal; a voltage regulator configured to supply a voltage of a predetermined level to the antenna via the connector, and detect an electric current flowing through the connector; and at least one processor configured to control the voltage regulator to adjust the control signal outputted by the tuner based on a channel selection for the broadcast signal, and in response to the electric current flowing through the connector being detected by the voltage regulator, determine that the antenna is connected to the connector and perform a setting for the broadcast signal.

### CROSS-REFERENCE TO RELATED APPLICATION

This application claims priority from Korean Patent Application No. 10-2016-0111166, filed on Aug. 30, 2016, in the Korean Intellectual Property Office, the disclosure of which is incorporated herein by reference in its entirety.

### BACKGROUND

### Field

Apparatuses and methods consistent with exemplary embodiments relate to a broadcast signal receiving apparatus and a control method thereof, and more particularly to a broadcast signal receiving apparatus for receiving a broadcast signal from a satellite and a control method thereof.

### Description of Related Art

A broadcast signal receiving apparatus receives a broadcast signal, such as a satellite broadcast signal, a cable broadcast signal, a terrestrial broadcast signal and the like, and processes the received broadcast signal to display as an image. The broadcast signal receiving apparatus may display the image on its own display panel or output the processed broadcast signal to other display apparatus with the display panel to display the image thereon. The former is called a display apparatus and as an example thereof, there is a television (TV). As an example of the latter, there is a set-top box.

The broadcast signal receiving apparatus that receives the broadcast signal may be variously implemented. For example, the broadcast signal receiving apparatus may receive the broadcast signal via a cable directly connected thereto from broadcasting equipment of a broadcasting station. The broadcast signal receiving apparatus may receive the broadcast signal in the form of a radio frequency (RF) signal by wireless via a RF antenna connected by wire thereto. The broadcast signal receiving apparatus may receive the broadcast signal via a satellite antenna.

The satellite antenna receives the broadcast signal by wireless from a satellite located on a geostationary orbit round the earth. The broadcast signal may be transmitted to the broadcast signal receiving apparatus via a ground relay apparatus or directly transmitted to the broadcast signal receiving apparatus by wire from the antenna. The ground relay apparatus may include a low noise block down converter (LNB) provided in the satellite antenna, and a switch for satellite selection. The broadcast signal receiving apparatus processes the broadcast signal received from the satellite antenna and displays the image based on the broadcast signal receiving apparatus.

To watch the satellite broadcast received as described above with the broadcast signal receiving apparatus, a user needs to select the satellite antenna as an external input source from initial settings. In other words, a general broadcast signal receiving apparatus does not have a function of automatically detecting whether it is connected to the satellite antenna and changing the external input source. Accordingly, since the user should manually select the satellite antenna as the input source to normally watch the broadcast, there are concerns about causing discomfort to those users that are not used to using the apparatus.

### SUMMARY

Exemplary embodiments may address at least the above problems and/or disadvantages and other disadvantages not described above. Also, the exemplary embodiments are not required to overcome the disadvantages described above, and may not overcome any of the problems described above.

According to an aspect of an exemplary embodiment, there is provided a broadcast signal receiving apparatus including: a connector configured to connect the broadcast signal receiving apparatus to an antenna; a tuner configured to output a control signal to the antenna via the connector such that the antenna tunes a broadcast signal based on the control signal; a voltage regulator configured to supply a voltage of a predetermined level to the antenna via the connector, and detect an electric current flowing through the connector; and at least one processor configured to: control the voltage regulator to adjust the control signal outputted by the tuner based on a channel selection for the broadcast signal, and in response to the electric current flowing through the connector being detected by the voltage regulator, determine that the antenna is connected to the connector and perform a setting for the broadcast signal.

The at least one processor may be further configured to set an output voltage of the voltage regulator to a predetermined default voltage, the voltage regulator may be further configured to detect the electric current flowing through the connector in response to the predetermined default voltage being set, and the predetermined default voltage may be determined based on a first reference voltage or a second reference voltage, wherein the first reference voltage and the second reference voltage are output voltages of the voltage regulator generated based on the channel selection.

The second reference voltage may have a level higher than the first reference voltage, and the predetermined default voltage may have a level higher than the second reference voltage.

The second reference voltage may have a level higher than the first reference voltage, and the predetermined default voltage may have a level higher than 0 and lower than the first reference voltage.

The at least one processor may be further configured to, in response to the electric current flowing through the connector being not detected by the voltage regulator, set an output voltage of the voltage regulator to a predetermined default voltage, and the voltage regulator may be configured to, in response to the predetermined default voltage being set, detect the electric current flowing through the connector.

The voltage regulator may be further configured to detect if an electric current equal to or greater than a predetermined reference current flows through the connector.

The at least one processor may be further configured to, in response to determining that the antenna is connected to the connector, reset an output voltage of the voltage regulator to 0.

The at least one processor may be further configured to, in response to determining that the antenna is connected to the connector, perform an automatic channel tuning for the broadcast signal received through the antenna.

The at least one processor may be further configured to, in response to determining that the antenna is connected to the connector, change an image source for the broadcast signal receiving apparatus to the antenna.

The apparatus may further include: a display; and a user input interface, wherein the at least one processor is further configured to, in response to an external input button provided in the user input interface being selected, control the display to display the antenna as a connected external input.

According to another aspect of an exemplary embodiment, there is provided a method of controlling a broadcast signal receiving apparatus to receive a broadcast signal from an antenna, including: setting an output voltage of a voltage regulator to a predetermined default voltage, the voltage regulator being configured to supply a voltage of a predetermined level to the antenna via a connector to which the antenna is connectable; in response to the predetermined default voltage being set, detecting an electric current flowing through the connector; and in response to the electric current flowing through the connector being detected, determining that the antenna is connected to the connector and performing a setting for the broadcast signal received from the antenna.

The predetermined default voltage may be determined based on a first reference voltage or a second reference voltage, the first reference voltage and the second reference voltage being output voltages of the voltage regulator generated based on a channel selection for the broadcast signal.

The second reference voltage may have a level higher than the first reference voltage, and the predetermined default voltage may have a level higher than the second reference voltage.

The second reference voltage may have a level higher than the first reference voltage, and the predetermined default voltage may have a level higher than 0 and lower than the first reference voltage.

The setting of the output voltage of the voltage regulator may include, in response to the electric current flowing through the connector being not detected, setting the output voltage of the voltage regulator to the predetermined default voltage.

The detecting of the electric current flowing through the connector may include detecting if an electric current equal to or greater than a predetermined reference current flows through the connector.

The method may further include: in response to determining that the antenna is connected to the connector, resetting the output voltage of the voltage regulator to 0.

The method may further include: in response to determining that the antenna is connected to the connector, performing an automatic channel tuning for the broadcast signal received through the antenna.

The method may further include: in response to determining that the antenna is connected to the connector, changing an image source for the broadcast signal receiving apparatus to the antenna.

The method may further include: receiving a selection input for an external input button provided in a user input interface; and in response to the selection input for the external input button, displaying the antenna as a connected external input.

### BRIEF DESCRIPTION OF THE DRAWINGS

The above and other aspects, features, and advantages of certain embodiments will be more apparent from the following description taken in conjunction with the accompanying drawings, in which:

FIG. 1 is a view schematically illustrating a construction of a satellite broadcast system according to an exemplary embodiment;

FIGS. 2 to 4 are views illustrating examples in which the satellite broadcast system of FIG. 1 is implemented, respectively, according to an exemplary embodiment;

FIG. 5 is a block diagram illustrating a construction of a broadcast signal receiving apparatus according to an exemplary embodiment;

FIG. 6 is a block diagram illustrating a process of processing and transferring a broadcast signal at the broadcast signal receiving apparatus of FIG. 5;

FIG. 7 is a block diagram illustrating a construction of a voltage regulator according to an exemplary embodiment;

FIG. 8 is a view for explaining a voltage control operation of the voltage regulator according to an exemplary embodiment;

FIG. 9 is a view illustrating a screen, which displays whether an antenna is connected, at a broadcast signal receiving apparatus according to an exemplary embodiment;

FIGS. 10 and 11 are views illustrating screens, which are displayed for setting the broadcast signal, respectively, at a broadcast signal receiving apparatus according to an exemplary embodiment; and

FIG. 12 is a flowchart illustrating a control method of a broadcast signal receiving apparatus according to an exemplary embodiment.

### DETAILED DESCRIPTION OF EXEMPLARY EMBODIMENTS

Hereinafter, with reference to accompanying drawings, exemplary embodiments will be described in detail for those skilled in the art to work the present disclosure without difficulty. The exemplary embodiments are not limited to the embodiments provided herein, and may be achieved in various forms. To clearly describe the exemplary embodiments, those unrelated to the description have been omitted, and like reference numerals denote like elements throughout this specification. Also, in the following description of various exemplary embodiments, if terms, such as ‘include’, ‘have’ and the like, are used, those terms are used (unless expressly specified otherwise) for the purpose of indicating that features, numbers, steps, operations, elements or combinations thereof described in the description exist, and not for the purpose of excluding the possibility that more than one other feature, number, step, operation, element or a combination thereof exists or is added.

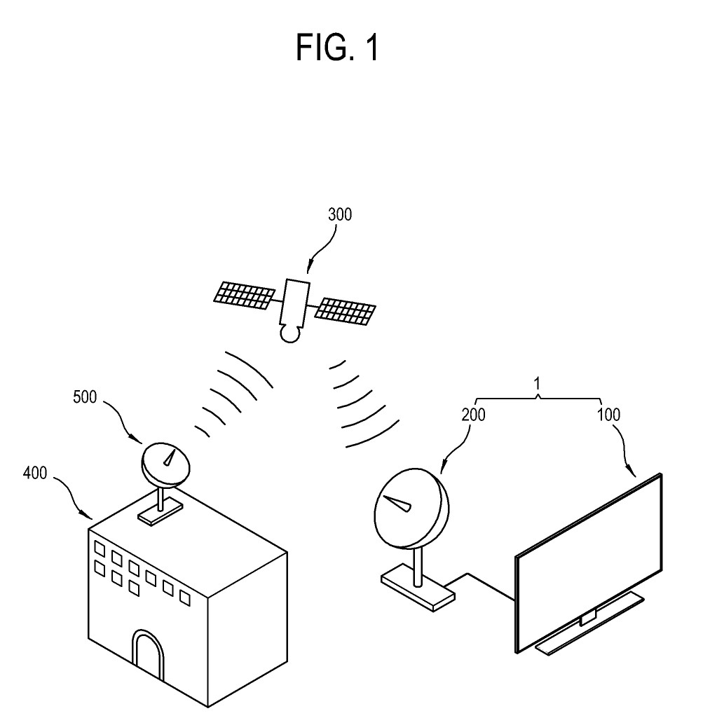

FIG. 1 is a view schematically illustrating a satellite broadcast system 1 according to an exemplary embodiment.

As illustrated in FIG. 1, the satellite broadcast system 1 according to an exemplary embodiment is basically configured to comply with a satellite relay-based signal transmission structure, and includes a ground relay apparatus 200 to receive a broadcast signal by wireless from a communication satellite 300, and a broadcast signal receiving apparatus 100 to receive the broadcast signal by wire from the ground relay apparatus 200 and process the received broadcast signal to display as an image. In FIG. 1, the broadcast signal receiving apparatus 100 is presented as a display apparatus, such as a television (TV), but is not limited thereto and may be implemented as a set-top box or other different types of devices.

The communication satellite 300 receives the broadcast signal from a broadcasting station 400, and amplifies and frequency-converts the received broadcast signal therein to resend to the ground. For instance, a radio frequency (RF) broadcast signal, which is outputted from broadcasting transmission equipment, e.g., a transmission antenna 500 of the broadcasting station 400, may be converted into an uplink signal and transmitted to the communication satellite 300. If receiving the uplink RF signal, the communication satellite 300 transmits a downlink RF signal corresponding to the uplink RF signal to the ground relay apparatus 200 on the side of the broadcast signal receiving apparatus 100.

In the communication satellite 300 may be provided a satellite relay apparatus, e.g., a transponder, which may amplify an uplink RF carrier within a predetermined frequency band and converts the amplified RF carrier (frequency) into a signal of 1 GHz or so.

In an exemplary embodiment, the ground relay apparatus 200 (hereinafter, also referred to an “relay apparatus”) connected to the broadcast signal receiving apparatus 100 receives a satellite broadcast signal from one or more communication satellite 300 in a geostationary orbit round the earth.

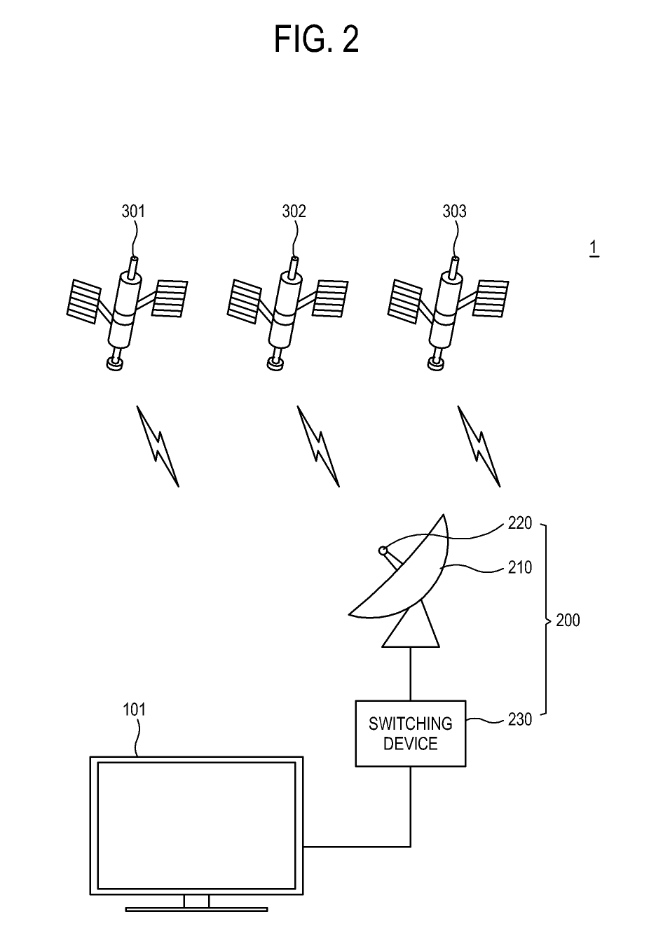

In response to a request from the broadcast signal receiving apparatus 100, the relay apparatus 200 may receive the downlink RF signal from the communication satellite 300 via one or more satellite dish, e.g., an antenna 210 in FIG. 2, and transfer the downlink RF signal to the broadcast signal receiving apparatus 100.

The broadcast signal receiving apparatus 100 processes the broadcast signal received via the relay apparatus 200 to display the broadcast signal as an image. If the broadcast signal receiving apparatus 100 is a TV, it displays a broadcasting image by itself. If the broadcast signal receiving apparatus 100 is a set-top box, it may output the processed image signal to a separate display apparatus to display an image thereon.

FIGS. 2 to 4 are views illustrating examples of the satellite broadcast system according to an exemplary embodiment.

As illustrated in FIGS. 2 to 4, the satellite broadcast system 1 according to an exemplary embodiment includes at least one broadcast signal receiving apparatus 101, 102, 104, 105, 106, and/or 107 to receive and process a broadcast signal, a ground relay apparatus 200 to relay a satellite broadcast signal and at least one communication satellite 301, 302, and/or 303 to transmit the satellite broadcast signal.

As illustrated in FIGS. 2 to 4, the ground relay apparatus 200 may include a satellite antenna 210, a low noise block down converter (LNB) 220, and a switching device 230 (hereinafter, also referred to a “switch box”).

The satellite antenna 210 may be implemented as a parabola antenna which is usually installed outdoors. The parabola antenna may have a disc shape with a concaved center, and may be driven by a separate motor to change its orientation. The satellite antenna 210 may receive the satellite broadcast signal from any one of the at least one communication satellite 301, 302, and/or 303 according to its orientation. For example, one satellite antenna 210 may receive the satellite broadcast signal from one communication satellite.

The LNB 220 may be provided in the satellite antenna 210 to convert and amplify a high frequency signal (for example, if Ku-band, 10,700 to 12,700 MHz) transmitted from the communication satellite into a signal of 1 GHz or so (for example, a signal within a range of 650 to 2,150 MHz), which is processable by the at least one broadcast signal receiving apparatus 101, 102, 104, 105, 106, and/or 107. Also, the LNB 220 may remove a noise included in the signal received through the satellite antenna 210. Installation types and locations of the LNB 220 are not limited to illustrations and explanations as described above with respect to FIGS. 2 to 4.

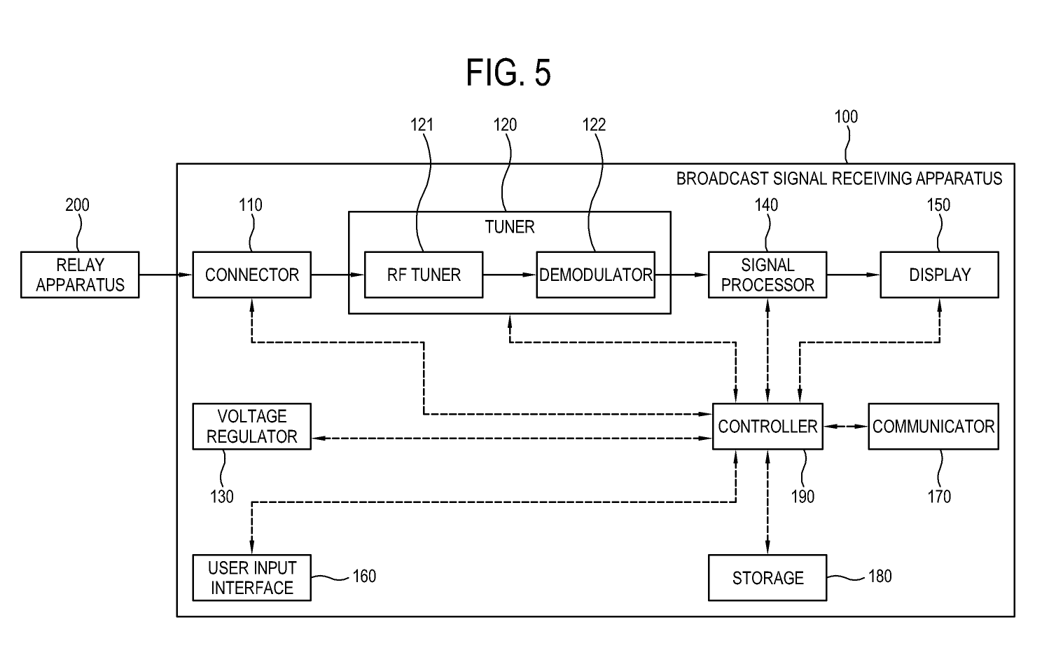

The switching device 230 may control the satellite antenna 210 to enable a selective reception of the broadcast signal according to a voltage level (for example, 13V or 18V) of a control signal received from a tuner (120 in FIG. 5) to be described later. The broadcast signal received from the communication satellite 301, 302, and 303 may include a vertical polarization and a horizontal polarization, and thus the switching device 230 may control the satellite antenna 210, for example, to receive the broadcast signal from any one of the communication satellite 301, 302 and 303 corresponding to the vertical polarization or the horizontal polarization. The selective reception, i.e., switching of the broadcast signal (the vertical polarization (V) or the horizontal polarization (H)) according to the voltage level as described above is called an H/V polarization switching.

In an exemplary embodiment, the switching device 230 may be implemented as an automatic satellite selector, for example, a digital satellite equipment control (DiSEqC) switch, which automatically selects a satellite according to a channel selection of user.

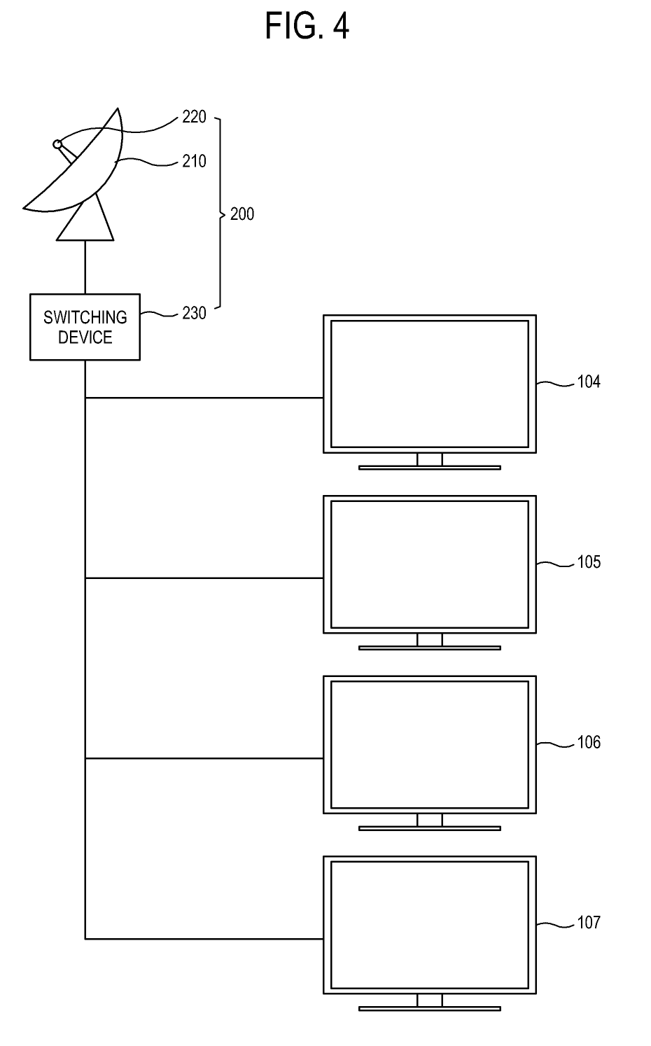

In another exemplary embodiment, the switching device 230 may be implemented as a channel router, for example, a satellite channel router (SatCR), which receives a channel change command from a plurality of broadcast signal receiving apparatus 104, 105, 106, and 107 using an unicable or signal cable, as illustrated in FIG. 4. Here, the SatCR is also called a satellite control router or a single cable router.

In other exemplary embodiment, the relay apparatus 200 may not include a separate switching device 230 and the broadcast signal receiving apparatus 100 may be directly connected with the satellite antenna 210.

The relay apparatus 200 including the LNB 220 may be supplied with a driving electric power from the broadcast signal receiving apparatus 100 via a cable wire. In other words, the relay apparatus 200 according to an exemplary embodiment does not need an external power or a separate battery for power supply.

The broadcast signal receiving apparatus 100 according to an exemplary embodiment may be implemented as at least one TV 101, 104, 105, 106 and/or 107, which receives and processes the broadcast signal and displays the processed broadcast signal as an image, as illustrated in FIGS. 2 and 4.

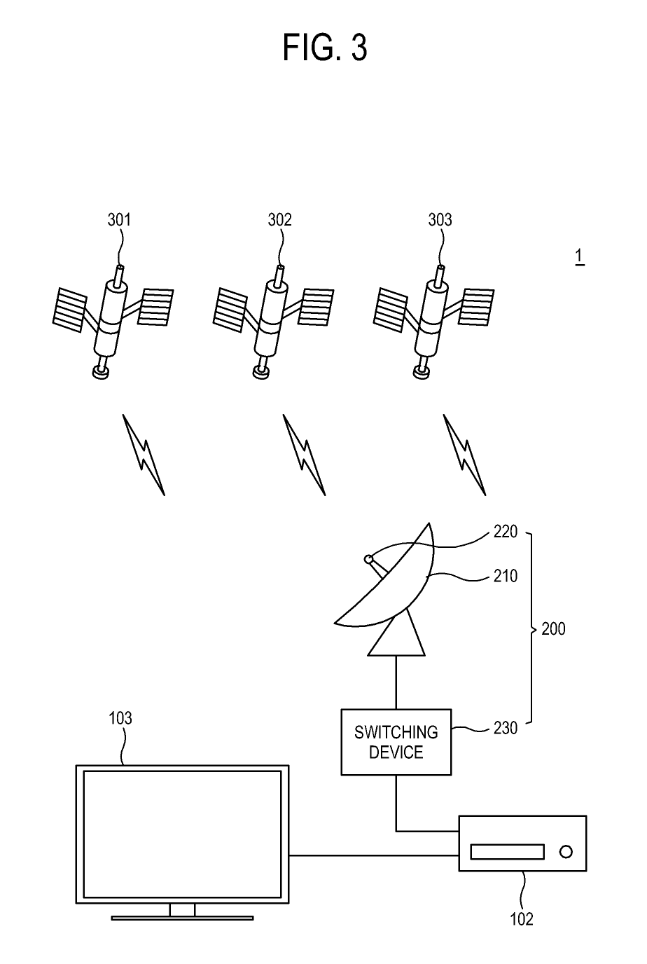

The broadcast signal receiving apparatus 100 according to another exemplary embodiment may be implemented as a set-top box 102 to output an audio/video signal to a display apparatus 103, such as a TV, as illustrated in FIG. 3.

The broadcast signal receiving apparatus 100 receives the broadcast signal from an image source, such as a broadcasting station, i.e., a headend.

Exemplary embodiments described below relate to implementing the broadcast signal receiving apparatus 100 as a satellite broadcast signal receiving apparatus, which processes the broadcast signal based on broadcast signal/broadcasting information/broadcasting data received from the communication satellite. However, types of the broadcast signal processed by the broadcast signal receiving apparatus 100 are not limited to the satellite broadcast signal. For instance, the broadcast signal receiving apparatus 100 may receive an image signal from various types of external apparatuses. Examples of the external apparatuses may include, but are not limited to, a mobile device including a smart phone, a smart pad, a tablet personal computer (PC), a MP3 player, and a PC including a desktop PC or a laptop PC. Also, the broadcast signal receiving apparatus 100 may process a signal to display on a display apparatus 101 or 103, motion images, still images, applications, on-screen display (OSD), user interfaces (UI) (e.g., Graphic User Interface (GUI)) for controlling various operations, etc., based on signals/data stored in storage media of the inside/the outside.

On the other hand, the broadcast signal received by the broadcast signal receiving apparatus 100 may be also received via terrestrial broadcasting, cable broadcasting and so on and the image source according to an exemplary embodiment is not limited to the broadcasting station. In other words, the image source according to an exemplary embodiment may include any apparatus or station if it can transmit and receive formation.

In exemplary embodiments as illustrated in FIGS. 2 to 4, the display apparatuses 101, 104, 105, 106, and 107 may be implemented as a smart TV or an internet protocol (IP) TV. The smart TV is a TV, which receives and processes a broadcast signal to display an image in real time, and has a web browsing function to retrieve and consume various contents via an internet while displaying the image of the broadcast signal in real time, thereby providing a convenient user environment for those. Also, the smart TV may include an open software platform to provide the user with a bidirectional service. Accordingly, the smart TV may provide the user with many contents, for example, applications for providing specific services, via the open software platform. The applications as application programs capable of providing various types of services, includes applications, which provides services, such as, for example, social network services(SNSs), news, weathers, maps, music, movies, games, electronic books, etc.

In an exemplary embodiment as illustrated in FIG. 3, the display apparatus 103 may be provided with a service, such as a Video-On-Demand (VOD), from a service provider via the broadcast signal receiving apparatus 102, e.g., the set-top box.

Also, the broadcast signal receiving apparatus 100 according to an exemplary embodiment may be, for example, a monitor connected to a main computer.

The broadcast signal receiving apparatus 100 according to an exemplary embodiment may communicate with the relay apparatus 200 based on a preset communication protocol. For instance, if a channel change event occurs by the user, the broadcast signal receiving apparatus 100 may transmit a control signal, i.e., a command corresponding to the event, to the relay apparatus 20, and receive and process a broadcast signal via the relay apparatus 200 according to the command.

Various types of standards may be applied to the communication protocol or format for communication between the broadcast signal receiving apparatus 100 and the relay apparatus 200. Bilateral communication is possible if both the broadcast signal receiving apparatus 100 and the relay apparatus 200 support the same standard to be applied. According to an exemplary embodiment, a DiSEqC may be applied as a communication standard between the broadcast signal receiving apparatus 100 and the relay apparatus 200.

FIGS. 1 to 3 illustrate examples of systems 1 in which one broadcast signal receiving apparatus 100 is connected to one relay apparatus 200. However, in other exemplary embodiment, a system 1 may be implemented to include one relay apparatus 200 and a plurality of broadcast signal receiving apparatuses 104, 105, 106 and 107, as illustrated in FIG. 4. In this case, the plurality of broadcast signal receiving apparatuses 104, 105, 106 and 107 may be connected to corresponding nodes of the unicable connected to the relay apparatus 200. At respective nodes of the unicable may be installed as physical sockets, slots or ports to enable the plurality of broadcast signal receiving apparatuses 104, 105, 106 and 107 to be connected thereto, respectively.

In other words, exemplary embodiments to be described below are merely examples, which may be variously modified and applied according to implementation methods of the system, and they do not limit a spirit of the inventive concept of the present disclosure.

Hereinafter, detailed structure of the broadcast signal receiving apparatus 100 according an exemplary embodiment will be described with reference to the drawings.

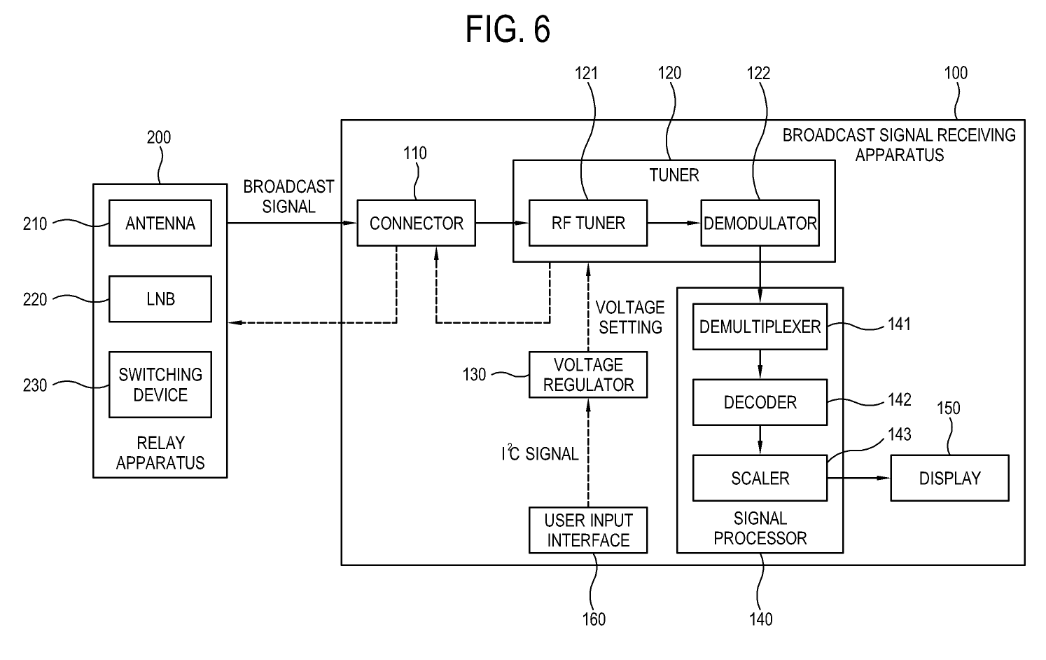

FIG. 5 is a block diagram illustrating a structure of the broadcast signal receiving apparatus 100 according to an exemplary embodiment. FIG. 6 is a block diagram illustrating a process of processing and transferring a broadcast signal at the broadcast signal receiving apparatus 100 of FIG. 5. Since the broadcast signal receiving apparatus 100 of the drawings has a structure similar to those of the broadcast signal receiving apparatuses 100, 101, 102, 104, 105, 106 and 107 as described above with reference to FIGS. 1 to 4, it may be applied to each of the broadcast signal receiving apparatuses 100, 101, 102, 104, 105, 106 and 107 of FIGS. 1 to 4.

As illustrated in FIG. 5, the broadcast signal receiving apparatus 100 according to an exemplary embodiment may include a connector 110 to which an antenna 210 for receiving a broadcast signal is connectable, a tuner 120 to tune the received broad signal by channel, a voltage regulator 130 to enable the tuner 120 to output a control signal having a voltage of predetermined level to the antenna, a signal processor 140 to receive the broadcast signal from the tuner 120 and to process the broadcast signal to be displayed as an image, a display 150 to display an image corresponding to the broadcast signal processed by the signal processor 140, a user input interface 160 to receive a user input, a communicator 170 to perform a communication with the outside, a storage 180 to store various data, and a controller 190 to control the broadcast signal receiving apparatus 100.

The connector 110 may be provided on an input side of the tuner 120, and include a connection jack for connection by wire with the relay apparatus 200 via a cable. In an exemplary embodiment, the connector 110 has a cable, for example, a coaxial cable connected thereto to receive the broadcast signal from the relay apparatus 200.

In the broadcast signal receiving apparatus 100 according to an exemplary embodiment, the connector 110 may be directly connected with the antenna 210 or connected with the antenna 210 via a switching device 230.

In an exemplary embodiment, the connector 110 includes a DiSEqC interface, which supports data communication with the relay apparatus 200 by a cable wire.

A DiSEqC protocol permits conversions between a plurality of satellite sources according to a version thereof, and a satellite motor may be provided in the relay apparatus 200 to adjust an orientation of the satellite antenna of the relay apparatus 200.

The DiSEqC interface permits a bidirectional communication between the broadcast signal receiving apparatus 100 and the relay apparatus 200 such that the broadcast signal receiving apparatus 100 and the relay apparatus 200 send and receive commands to each other.

When a channel selection for the broadcast signal is received through the user input interface 160, the broadcast signal receiving apparatus 100 according to an exemplary embodiment outputs a command, which has a voltage level corresponding to the broadcast signal and includes channel information of the selected channel, to the relay apparatus 200. Here, a control signal according to a predetermined voltage level of 13V or 18V, i.e., the command, may be generated and outputted by the tuner 120 of the broadcast signal receiving apparatus 100. The command may be a DiSEqC command with a format according to the DiSEqC protocol. A voltage level of the command may be set to 13V or 18V by the voltage regulator 130 to correspond to the channel selection.

The DiSEqC command is digitally defined and composes ‘0’ and ‘1’ corresponding to a digital bit using a tone signal of 22 KHz, which is an analog signal. The DiSEqC command composed of bits as described above is transmitted to the relay apparatus 200 via the cable, so that a switching of the satellite source, e.g., H/V polarization switching, is performed by the switching device 230. With this, by the tone signal of the DiSEqC command, a control of reception band may be controlled at the LNB 230.

In another exemplary embodiment, the switching device 230 of the relay apparatus 200 may be implemented as a channel router, e.g., a SatCR, which receives a channel change command from a plurality of broadcast signal receiving apparatuses using a unicable or a signal cable. If the channel router is used, the DiSEqC command may be defined as follows.

First, a LNB voltage may be switched from 13V to 18V by the voltage regulator 130 during a channel change according to a selection of user, and a DiSEqC command of 18V in which information on the changed channel is included may be outputted from the tuner 120.

Then, a voltage may change from 18V to 13V by the voltage regulator 130. Here, since the SatCR is to allow the plurality of broadcast signal receiving apparatuses to send and receive data to and from the relay apparatus 200 using the unicable, a command including information for identifying a corresponding broadcast signal receiving apparatus (or tuner), e.g., a port number, may be outputted. Also, if a command output from any one of the broadcast signal receiving apparatus is completed, a process of changing a voltage level from 18V to 13V is performed to enable a command output from another broadcast signal receiving apparatus.

On the other hand, in an exemplary embodiment, the connector 110 may further receive an image signal based on a standard, such as a composite video, a component video, a super video, a SCART, a high definition multimedia interface (HDMI) and so on by a cable or the like.

The tuner 120 (hereinafter, also referred to a tuner module or tuner circuitry) may include a RF tuner 121 and a demodulator 122.

In an exemplary embodiment, the RF tuner 121 receives a broadcast signal, i.e., a RF signal transmitted from a satellite 300, by a cable wire via the relay apparatus 200.

The RF tuner 121 may tune the broadcast signal by channel. The RF tuner 121 may implemented as an RF integrated circuit (IC), which includes, for example, a mixer, a phase locked loop (PPL) and an oscillator.

In an exemplary embodiment, the RF tuner 121 may mix the broadcast signal with an oscillation frequency, convert the mixed signal into an intermediate frequency, i.e., down-convert the mixed signal, amplify the down-converted signal and then output the amplified signal to the demodulator 122. For example, the signal outputted to the demodulator 122 may include a filtered quadrature phase shift keying (QPSK) modulation signal or an 8 octal phase shift keying (8PSK) modulation signal.

The demodulator 122 demodulates a digital broadcast signal of the tuned specific channel and outputs the demodulated signal as a signal in the form of a transport stream (hereinafter, also referred to a ‘TS’). The demodulator 122 may receive as the QPSK modulation signal, for example, signals for I channel and Q channel, i.e., IP, IN, QP and QN signals, demodulate the received signals, and outputs the demodulated signals as the TS signal.

In response to a channel change signal according to the channel selection of the user, the tuner 120 may output a control signal, which has a predetermined voltage level (e.g., 13V or 18v) and includes channel information of the selected channel, to the relay apparatus 200.

The broadcast signal receiving apparatus 100 according to an exemplary embodiment may be provided with a tuner 120 in which the RF tuner 121 and the demodulator 122 is integrated into one. The tuner 120 implemented as a signal construction, for example, a signal chip, as described above may be embedded on a printed circuit board, which is mounted in the broadcast signal receiving apparatus 100.

According to another exemplary embodiment, the RF tuner 121 and the demodulator 122 may be implemented as separate chips (e.g., a tuber chip and a demodulator chip) and embedded on the PCB.

The voltage regulator 130 adjusts a DC voltage converted from an external AC voltage to a predetermined level and supplies the adjusted DC voltage as a LNB voltage to the relay apparatus 200. In response to an inter integrated circuit (I2C) control signal received from the controller 190, the voltage regulator 130 controls the LNB voltage supplied to the relay apparatus 200. The I2C control signal may be generated, for example, in response to the channel selection of the user and may include information to enable a selective reception of the vertical polarization or the horizontal polarization according to the selected channel.

In response to the I2C control signal, the voltage regulator 130 may set a LNB voltage to correspond to a reference voltage level of 13V or 18V, so that the LNB voltage complies with the selected channel. Here, the process of setting the LNB voltage level of the voltage regulator 130 is the same as that as described with respect to the DiSEqC protocol at the connector 100 above. In below exemplary embodiments, 13V and 18V, which are set as the LNB reference voltage, will be defined as a first reference voltage and a second reference voltage, respectively.

In the broadcast signal receiving apparatus 100 according to an exemplary embodiment, to automatically check whether the broadcast signal receiving apparatus 100 and the antenna 210 are connected each other, the voltage regulator 130 may detect an electric current flowing through the connector 110 in real time.

For this, a DC voltage value (i.e., output voltage) of the voltage regulator 130 may be set to a default voltage of predetermined level. Here, the default voltage may have a level higher than the second reference voltage of 18V. For example, the default voltage may be set to 21V adding a margin of 3V to 18V.

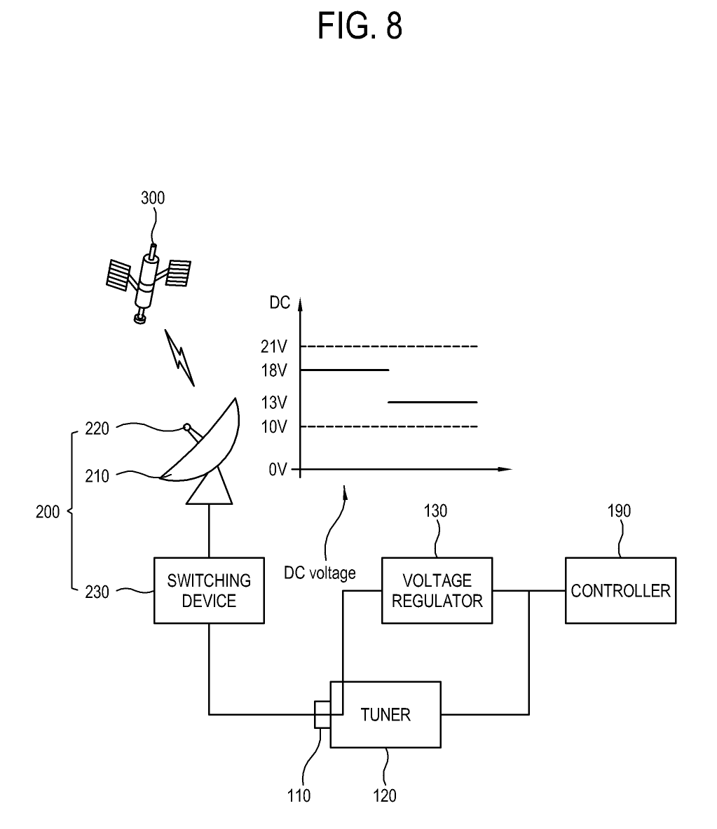

If it is detected that an electric current equal to or greater than a predetermined reference current flows through the tuner 120 and the connector 110 toward the relay apparatus 200 in a state where the default voltage is supplied to the relay apparatus 200, the voltage regulator 130 determines that the tuner 120 is connected to the relay apparatus 200 including the antenna 210. Here, a value of the predetermined reference current may be set to, for example, 10 mA. Specific exemplary embodiments related to this will be described in more detail with reference to FIG. 8 later.

The signal processor 140 performs various predetermined video/audio processing processes with respect to the broadcast signal received from the tuner 120. The signal processor 140 outputs an output signal which is generated or combined by the predetermined video/audio processing to the display 150 to display and output an image and a sound corresponding to the broadcast signal on the display 150.

As illustrated in FIG. 6, the signal processor 140 may include a demultiplexer 141 to separate the broadcast signal into signals having different characteristics, such as an image signal, an audio signal, all sorts of addition data and so on, a decoder 142 to decode a TS signal to correspond to an image format of the broadcast signal receiving apparatus 100, and a scaler 143 to adjust the broadcast signal to comply with an output standard of the display 150. The decoder 142 according to an exemplary embodiment may be implemented as, for example, a moving picture experts group (MPEG) decoder.

Here, kinds of the image processing processes performed by the signal processor 140 according to an exemplary embodiment are not limited to illustrations and explanations as described above with respect to FIG. 6. For instance, the signal processor 140 may further perform de-interlacing for converting the broadcast signal from an interlace form to a progressive form, noise reduction for improving image quality, detail enhancement, frame refresh rate conversion, etc. The signal processor 140 may be implemented as a group of individual constructions, each of which independently performing a corresponding image processing. The signal processor 140 may be implemented as a system-on-chip (SoC) in which various functions are integrated. In other words, the signal processor 140 may be implemented as a form, which is included in a main SoC embedded on a PCB in the broadcast signal receiving apparatus 100. The main SoC may include at least one processor, which is an example of implementing the controller 190 to be explained later. In this case, in the broadcast signal receiving apparatus 100 is provided the PCB on which a tuner chip corresponding to the tuner 120 and the main SoC are embedded.

The broadcast signal processed by the signal processor 140 is outputted to the display 150. The display 150 displays an image corresponding to the broadcast signal received from the signal processor 140.

In an exemplary embodiment, the display 150 is not limited to a specific type. For instance, the display 150 may be implemented in various display types, such as liquid crystal display (LCD), plasma display panel (PDP), light-emitting diode (LED) display, organic light emitting diodes (OLED) display, surface-conduction electron-emitter, carbon nano-tube, nano-crystal display, etc.

Also, the display 150 may include additional constructions according the implemented types. For instance, if the display 150 is a LCD type, the display 150 includes a LCD panel (not shown), a backlight unit to supply light to the LCD panel, a panel driving board to drive the LCD panel, etc.

The display 150 according to an exemplary embodiment may include a touch screen, which receives an input based on a touch input of user. The touch screen may be implemented, for example, in a resistive type, a capacitive type, an infrared type, or an acoustic type.

The touch screen as a user interface (UI) may display objects including various menu items (for example, menus, texts, images, videos, figures, icons, and shortcut icons). The user may touch the objects displayed on the touch screen with her or his body (for example, a finger) or a separate pointing device, such as a stylus, to input a user input.

The touch screen may provide UIs corresponding to various services (for example, phone call, data transmission, broadcasting, photograph shooting, motion image, or application). The touch screen may recognize an analog signal corresponding to a single touch or a multi touch inputted via the UIs, and transmit the recognized signal to the controller 190. Here, the touch input includes drag, flick, drag and drop, tap, long tap, etc.

On the other hand, if the broadcast signal receiving apparatus 100 is implemented as a set-top box, it may further include an A/V output, which outputs the video or audio signal processed at the signal processor 140 to the display apparatus (103 in FIG. 3) connected via a data communication cable, such as, a D-sub cable or the like. The A/V output is connected with an A/V input of the display apparatus 103 to transmit the video or audio signal thereto.

The user input interface 160 as illustrated in FIG. transmits predetermined various control commends or unlimited information to the controller 190 according to manipulations or inputs of the user.

In an exemplary embodiment, the user input interface 160 includes a key pad (or input panel), which is provided on a main body of the broadcast signal receiving apparatus 100 and includes a power key, a digit key, a menu key, etc. The user input interface 160 may be implemented to further receive a user input from input devices, such as a remote control, a keyboard, a mouse and so on, which are isolated and/or separated from the main body. The remote control generates commands/data/information/signals predetermined to remotely control the broadcast signal receiving apparatus 100, and transmits the generated commands/data/information/signals to the broadcast signal receiving apparatus 100. The remote control may be provided with a touch sensor to receive a touch input of the user and/or a motion sensor to detect a motion of the remote control itself by the user.

The input devices may be external devices, which can communicate by wireless or by cable with the main body of the broadcast signal receiving apparatus 100. The wireless communication include Bluetooth (BT), infrared communication, wireless local area network (LAN), wireless fidelity (Wi-Fi) direct, etc. The input devices are manipulated by the user, so that they transmit predetermined commands to the broadcast signal receiving apparatus 100.

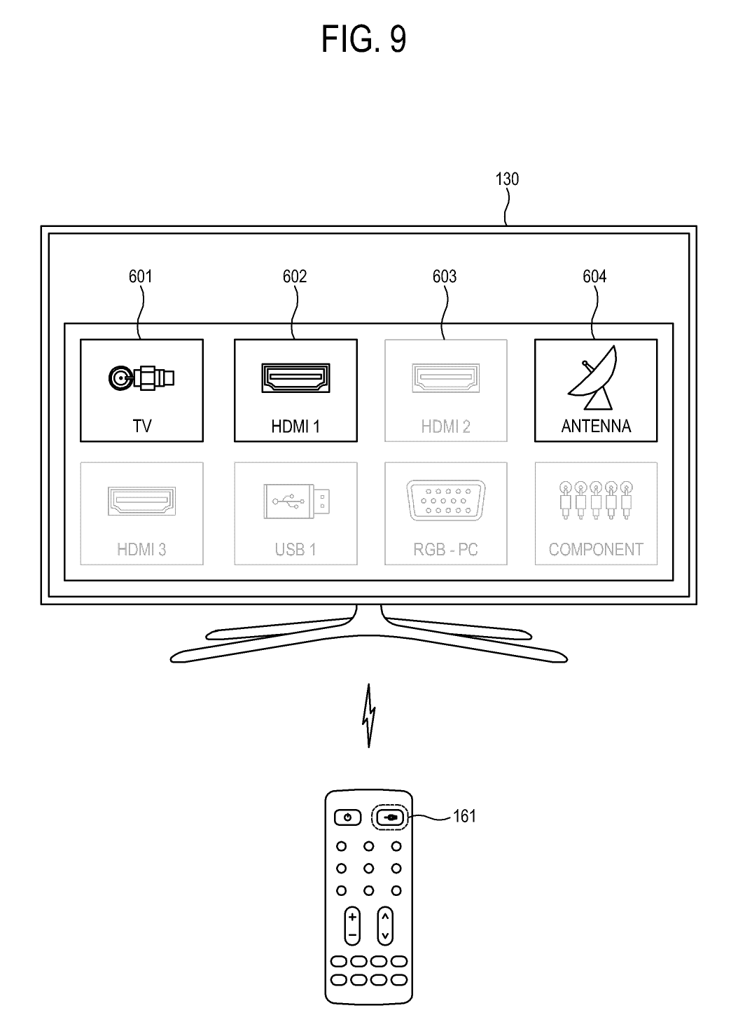

The broadcast signal receiving apparatus 100 according to an exemplary embodiment includes an external input button (hereinafter, also referred to an external input key, a source button or a source key) (161 in FIG. 9) provided as the user input interface 160. The external input button 161, which is provided to select an image source for supplying the broadcast signal, i.e., a broadcast signal source, may be included in the remote control provided as the input device.

In an exemplary embodiment, the broadcast signal source includes a terrestrial broadcasting, a HDMI, a satellite antenna, and so on, and may transmit and receive a signal to and from the tuner 120 via the connector 110.

The key pad may include a physical key pad installed on a front or lateral side of the broadcast signal receiving apparatus 100. The key pad may include a virtual key pad configured to be displayed on the display 150. The key pad may include a physical key pad configured to be connectable by wireless. It will readily be understood by those in the art that the physical key pad installed on the front or lateral side of the broadcast signal receiving apparatus 100 may be excluded according to a performance or structure of the broadcast signal receiving apparatus 100.

The broadcast receiving apparatus 100 according to an exemplary embodiment receives a user input for source selection and/or a user input on channel selection from the user via the user input interface 160.

The communicator 170 may include a wired and/or wireless communication module for performing communications with various external apparatuses including the input devices.

The communicator 170 transmits commands/data/information/signals received from the external apparatuses to the controller 190. Also, the communicator 170 may transmit commands/data/information/signals received from the controller 190 to the external apparatuses.

The communicator 170 may include a wired and/or wireless communication interface, which performs data communications with the outside. For instance, the communicator 170 may further support at least one from among communication interfaces 1 to N, each of which includes wired LAN, BT, Wi-Fi direct, RF, Zigbee, wireless LAN, Wi-Fi, infrared communication, ultra-wide band (UVB), near field communication (NFC), etc. Here, the communicator 170 may use a wireless communication as a communication method between the broadcast signal receiving apparatus 100 and the input devices.

Although the communicator 170 is built into the main body of the broadcast signal receiving apparatus 100 in FIG. 5, it may be implemented in the form of a dongle or module to be detachably connected to a connector of the broadcast signal receiving apparatus 100.

The storage 180 stores various data according to a control of the controller 190. The storage 180 may include a non-volatile memory, a volatile memory, a flash memory, a hard disc drive (HDD) or a solid state drive (SSD). The storage 180 is accessed by the controller 190 and reads/writes/modifies/deletes/updates data under the control of the controller 190.

The date stored in the storage 180 includes, for example, an operating system (OS) for driving the broadcast signal receiving apparatus 100, and various applications, image data, additional data and so on, which are executable on the OS.

To be more specific, the storage 180 may store signals or data, which are inputted/outputted corresponding to respective operations of the components 110 to 170 according to the control of the controller 190. The storage 180 may store graphical user interfaces (GUIs) related to control programs for control of the broadcast signal receiving apparatus 100 and applications provided by a manufacturer or downloaded from the outside, images for providing the GUIs, user information, documents, databases, or related data.

In an exemplary embodiment, the term ‘storage’ may refer to the storage 180, a read only memory (ROM) and/or a random access memory (DRAM) in the controller 190, or a memory card (for example, a micro SD card, a memory stick, and so on) attachable in the broadcast signal receiving apparatus 100.

The controller 190 performs control needed for operating all the elements of the broadcast signal receiving apparatus 100. To be more specific, the controller 100 controls general operations of the broadcast signal receiving apparatus 100 and signal flows between the internal components 120 to 180 of the broadcast signal receiving apparatus 100, and performs data processing functions. For instance, the controller 190 may perform control operations corresponding to progresses of reception/separation/image processing processes for the broadcast signal that the tuner 120 and the signal processor 140 process and commands from the user input interface 160 including the input devices, thereby controlling the whole operation of the broadcast signal receiving apparatus 100.

If there is an input from the user or if a predetermined storage condition is satisfied, the controller 190 may execute the OS and the various applications stored in the storage 180.

In an exemplary embodiment, the controller 190 may include at least one processor, a ROM as a non-volatile memory in which the control programs for control of the broadcast signal receiving apparatus 100 are stored, and a RAM as a volatile memory in which signals or data inputted from the outside of the broadcast signal receiving apparatus 100 are stored. The volatile memory may be used as storing areas for various tasks performed at the broadcast signal receiving apparatus 100. The at least one processor loads and executes programs into and in the RAM from the ROM in which the programs are stored.

The controller 190 according to an exemplary embodiment may be implemented as at least one universal processor, such as a central processing unit (CPU), and an application processor (AP), a microcomputer (MICOM) and so on, so that, for example, according to a given algorithm stored in the ROM, it loads into the RAM and executes a corresponding program, thereby performing various operations of the broadcast signal receiving apparatus 100.

If the controller 190 of the broadcast signal receiving apparatus 100 is implemented as a single processor, for example, a CPU, it may be configured to execute various functions executable by the broadcast signal receiving apparatus 100, for example, control needed for progresses of various image processing processes, such as decoding, demodulating, scaling and so on, for an image displayed on the display 150, response for user commands received via the user input interface 160, control needed for wired and wireless network communications with the external apparatuses through the communicator 170, etc.

The at least one processor may include a single core, a dual core, a triple core, a quad core, and/or a multiple core of thereof. The at least one processor may include a plurality of processors, for example, a main processor and a sub processor to operate at a sleep mode (for example, that the broadcast signal receiving apparatus 100 is supplied only with a standby power and does not operate as a display apparatus). Also, the at least one processor, the ROM and the RAM may be connected to one another via an internal bus.

In an exemplary embodiment, if the broadcast signal receiving apparatus 100 is implemented as a monitor, the controller 190 may further include a graphic processing unit (GPU) for graphic processing.

Also, in another exemplary embodiment, if the broadcast signal receiving apparatus 100 is implemented as a digital TV, a smart phone or a smart pad, the at least one processor may include a GPU, and may be implemented in the form of a SoC in which the core and the GPU are combined.

On the other hand, in other exemplary embodiment, the controller 190 may include a program for specific function supported by the broadcast signal receiving apparatus 100, for example, transmitting a command to the relay apparatus 200 in response to a channel selection, and an chip (e.g., an IC chip) provided as a dedicated processor to execute the program.

In exemplary embodiment, the at least one processor, which is an example of implementing the controller 190, may be included in a main SoC, which is embedded on a PCB in the broadcast signal receiving apparatus 100. In another exemplary embodiment, the main SoC may further include the signal processor 140, which processes the broadcast signal to display as an image. In this case, the broadcast signal receiving apparatus 100 is provided with the PCB in which a tuner IC corresponding to the tuner 120, a LNB IC corresponding to the voltage regulator 130, and a main SoC for performing functions of the signal processor 140 and the controller 190 are embedded.

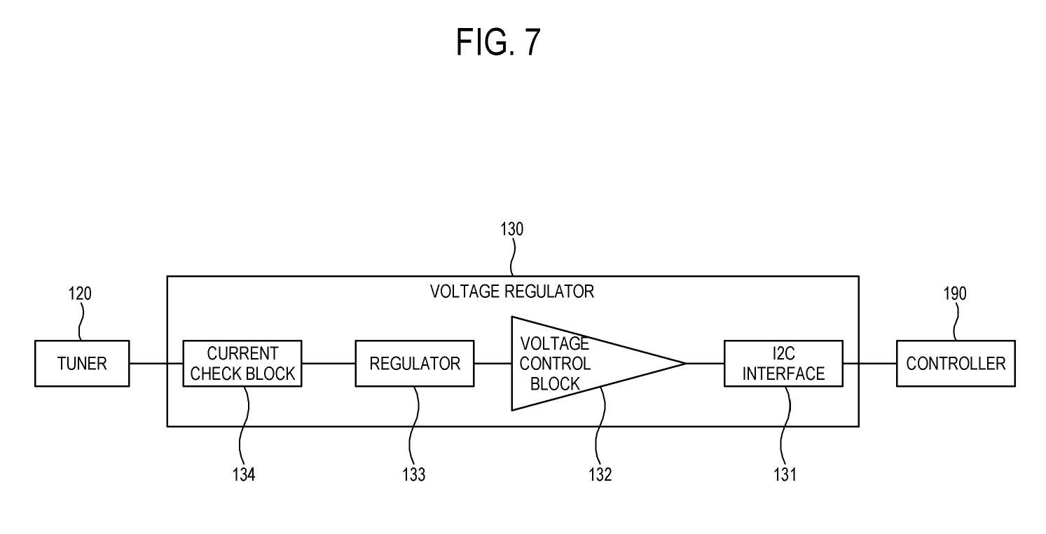

FIG. 7 is a block diagram of the voltage regulator 130 according to an exemplary embodiment. FIG. 8 is a view for explaining a voltage control operation of the voltage regulator 130.

The voltage regulator 130 provided in the broadcast signal receiving apparatus 100 according to an exemplary embodiment may be implemented as a chip, which is provided as a processor for supplying a voltage and a control signal to the replay apparatus 200. As an example, the voltage regulator 130 may be a LNB IC (hereinafter, also referred to a LNB processor, a LNBP, a LNB power supply or a LNB voltage source), which adjusts a LNB voltage supplied to the relay apparatus 200, and may be embedded on the PCB along with the tuner IC and the main SoC.

In an exemplary embodiment, as illustrated in FIG. 7, the voltage regulator 130 includes an I2C interface 131, a voltage control block 132, a regulator 133, and a current check block 134.

The controller 190 outputs an I2C control signal corresponding to a user input, for example, a channel selection, received via the user input interface 160 to the voltage regulator 130. The I2C control signal may include setting value information with respect to a LNB voltage according to the channel selection.

The I2C interface 131 interfaces to receive the I2C control signal from the controller 190 via an internal bus. According to the received I2C control signal, the voltage control block 132 sets a voltage of predetermined level (for example, 13V or 18V) as the LNB voltage to be supplied to the relay apparatus 200.

The regulator 133 regulates a voltage, so that a voltage corresponding to the predetermined level set by the voltage control block 132 is supplied to the relay apparatus 200 via the tuner 120, thereby supplying a constant voltage corresponding to a reference voltage level to the relay apparatus 200.

The current check block 134 may be located at front end of the voltage regulator 130 to check an electric current flowing toward the satellite antenna 210. In an exemplary embodiment, the current check block 134 may detect that an electric current equal to or greater than a predetermined reference value flows. The predetermined reference value may be set to 10 mA or more, which corresponds to a minute electric current.

According to an exemplary embodiment, the current check block 134 of the voltage regulator 130 may be provided as a hardware and/or software construction. For instance, an electric current may be detected by a current check block 134 composed of a circuit construction in the LNB IC 130 and/or by the LNB IC 130 performing the function of the current check block 134 by executing a program based on a given algorithm.

Hereinafter, a process of determining whether the satellite antenna is connected to the voltage regulator 130 will be described in more detail with reference to FIG. 8.

As illustrated in FIG. 8, the voltage regulator 130 of the broadcast signal receiving apparatus 100 according to an exemplary embodiment may supply a DC voltage to the relay apparatus 200 in response to an I2C control signal received from the controller 190.

The I2C control signal is generated by the controller 190 in response to an event occurrence, such as a channel selection of the user. The generated I2C control signal is outputted to the tuner 120 and the voltage regulator 130.

On receiving the I2C control signal from the controller 190, the voltage regulator 130 may output a signal having a voltage level corresponding the selected channel to the relay apparatus 200 via the tuner 120 and the connector 110. Specifically, the voltage regulator 130 supplies the voltage to the relay apparatus 200 and at the same time, allow the relay apparatus 200 to switch the broadcast signal received from the satellite 300 to the selected channel.

In the broadcast signal receiving apparatus 100 according to an exemplary embodiment, an event such as a channel selection is generated and an I2C command for setting a LNB voltage, i.e., the I2C control signal, is outputted from the controller 190 to the voltage regulator 130. In response to the received command, the voltage regulator 130 may set the LNB voltage to correspond to a first reference voltage (13V) or a second reference voltage (18V), so that the LNB voltage complies with the selected channel.

Then, the signal having the voltage level set by the voltage regulator 130, i.e., the command, may be outputted from the tuner 120 via the connector 110. Here, the outputted command may be a DiSEqC command as an example. The DiSEqC command in which DiSEqC data including channel information is superimposed into the signal of the set LNB voltage level may be formed, for example, such that a tone burst signal and a tone signal of 22 kHz are successively outputted at a given gap of time.

In the relay apparatus 200, the outputted DiSEqC command is received, and the setting for an outer satellite unit, i.e., the satellite 300, is configured based on the received DiSEqC command. To be more specific, in the relay apparatus 200, a H/V polarization switching according to the voltage level and a low/high band selection according to the selected channel are performed.

Then, the broadcast signal receiving apparatus 100 receives a corresponding broadcast signal from the satellite 300 via the relay apparatus 200 and the tuner 120 tunes the received broadcast signal according to the selected channel. The tuned broadcast signal is processed by the signal processor 140 and displayed as an image on the display 130 to allow the user to watch the image.

To allow the user to select a channel and to watch a satellite broadcasting corresponding to the selected channel in the same method as described above, there is a need for the broadcast signal receiving apparatus 100 to be connected to the antenna 210, i.e., the relay apparatus 200.

The broadcast signal receiving apparatus 100 according to an exemplary embodiment may automatically check whether the antenna 210 is connected thereto before an initial setting for broadcasting watching. Concrete exemplary embodiments on this are as follows.

In response to the I2C control signal from the controller 190, the voltage regulator 130 sets a DC voltage value (DC output) thereof to a default voltage of predetermined level. Such a setting of the default voltage may be automatically performed by the controller 190, for example, at initial power up during first installation of the broadcast signal receiving apparatus 100 in a house, regardless of a selection of the user.

At the initial power up after release, the controller 190 may power on the voltage regulator 130 and output the I2C control signal for setting the DC voltage of the voltage regulator 130 to the default voltage.

As the DC voltage of the voltage regulator 130 is set to the default voltage, an electric potential difference is formed between the relay apparatus 200 and an input side of the broadcast signal receiving apparatus 100, i.e., between the tuner 120 and the voltage regulator 130. And, an electric current according to the electric potential difference flows between the voltage regulator 130 and the relay apparatus 200, i.e., the antenna 210 via the connector 110 and the tuner 120.

The current check block 134 of the voltage regulator 130 may detect the electric current flowing through the connector 110. According to the detection result of the current check block 134, the controller 190 may determine that the antenna 210 is connected to the connector 110 of the broadcast signal receiving apparatus 100.

If the antenna 210 is not connected via the cable, the connector 110, i.e., an input side of the tuner 120, is in an open state, so that the electric current does not flow therethrough.

Here, even if the connector 110 is in the open state where the cable is not connected with the antenna 210, a minute electric current of very low level may flow through the connector 110.

Accordingly, in an exemplary embodiment, the current check block 134 may be provided to check that an electric current equal to or greater than a predetermined reference current flows. Here, the predetermined reference current may be, for example, 10 mA. In another exemplary embodiment, the controller 190 may receive an electric current value detected by the current check block 134. If the received electric current value is greater than or equal to the predetermined reference current, the controller 190 may determine that the antenna 210 is connected. If the electric current value detected by the current check block 134 is less than the predetermined reference current, the controller 190 may determine that the antenna 210 is not connected.

In the broadcast signal receiving apparatus 100 according to an exemplary embodiment, a level of the default voltage may be determined taking account of various connection types of the antenna 210 and the tuner 120.

In an exemplary embodiment, if the relay apparatus 200 installed outside the house is not connected with other broadcast signal receiving apparatuses, but is only connected with the broadcast signal receiving apparatus 100, the relay apparatus 200 may have a voltage of 0V. In this case, as long as the default voltage is greater than 0, an electric current will flow through the connector 110, thus it is possible to check whether the antenna 210 is connected. The broadcast signal receiving apparatus 100 may be connected to the antenna 210 via the switching device 230, or may be directly connected to the antenna 210 by a cable.

In another exemplary embodiment, as illustrated in FIG. 4, if a plurality of broadcast signal receiving apparatuses 104, 105, 106 and 107 receive a broadcast signal by sharing one antenna 210, the relay apparatus 200 may have a voltage of any one of 0V, 13V, and 18V. The sharing as described above includes a case where the switching device 230 is implemented as a channel router having a plurality of ports provided therein.

For instance, if the satellite antenna 210 is connected to a plurality of broadcast signal receiving apparatuses 105, 106 and 107, the user may want to watch the satellite broadcasting received from the same antenna 210 using a new broadcast signal receiving apparatus 104.

In this case, a DiSEqC command including channel information may be transmitted from at least one of the broadcast signal receiving apparatuses 105, 106 and 107 to the relay apparatus 200, so that the relay apparatus 200 has a voltage of 13V or 18V.

Accordingly, broadcast signal receiving apparatus 100 according to the following exemplary embodiments 1 to 3 may automatically check whether the antenna 210 is connected regardless of whether the antenna 210 is shared.

### Exemplary Embodiment 1

First, a default voltage may be set to a voltage level higher than 18V of the second reference voltage, which is a high voltage from among LNB reference voltages that are supplied to the relay apparatus 200 to receive a broadcast signal according to a channel selection. As an example, the default voltage may be determined as 21V adding a predetermined margin (for example, 3V) to the second reference voltage (18V).

Accordingly, an electric potential difference occurs between the relay apparatus 200 having a voltage level of any one of 0V, 13V and 18V and the voltage regulator 130 having the voltage level of 21V. And, an electric current according to the electric potential difference flows into the relay apparatus 200, i.e., the antenna 210 from the voltage regulator 130 via the connector 110 and the tuner 120.

### Exemplary Embodiment 2

As another example, a default voltage may be set to have a voltage level higher than 0V and lower than 13V of the first reference voltage, which is a low voltage from among the LNB reference voltages that are supplied to the relay apparatus 200 to receive the broadcast signal according to the channel selection. As an example, the default voltage may be determined as 10V subtracting a predetermined margin (for example, 3V) from the first reference voltage (13V).

Thus, an electric potential difference occurs between the relay apparatus 200 having a voltage level of any one of 0V, 13V and 18V and the voltage regulator 130 having the voltage level of 10V. Here, if the relay apparatus 200 has a voltage of 13V or 18V, an electric current according to the electric potential difference flows into the voltage regulator 130 from the relay apparatus 200, i.e., the antenna 210, via the connector 110 and the tuner 120. Also, if the relay apparatus 200 has a voltage of 0V, an electric current according to the electric potential difference flows into the voltage regulator 130 via the connector 110 and the tuner 120 from the relay apparatus 200, i.e., the antenna 210.

### Exemplary Embodiment 3

In this exemplary embodiment, 1) without applying a default voltage, the current check block 134 first checks whether an electric current flows through the connector 110, and 2) if the electric current is not detected, the voltage regulator 130 sets an output voltage thereof to a predetermined default voltage. In other words, it is determined whether the antenna 210 is connected by successively performing operations of two steps. This method may be applicable to a case where the antenna 210 is shared and used, as in FIG. 4.

For instance, if a command including channel information is outputted by other broadcast signal receiving apparatuses and thereby the relay apparatus 200 has a voltage of 13V or 18V, an electric current flows into the voltage regulator 130 from the antenna 210 via the connector 110 and the tuner 120 by cable connection, even though the output voltage is not set by the voltage regulator 130. Accordingly, without setting the default voltage at the first step 1), it may be checked whether the antenna 210 is connected.

Here, if the electric current is not detected, in response to the voltage regulator 130 setting the output voltage thereof to the predetermined default voltage at the second step 2), an electric current flows into the relay apparatus 200 from the voltage regulator 130 via the tuner 120 and the connector 110. Thus, even if the voltage of the relay apparatus 200 is 0V, it may be checked whether the antenna 210 is connected.

In the exemplary embodiment 3, since it's based upon the premise that the output voltage of the voltage regulator 130 is set to the predetermined default voltage if the voltage of the relay apparatus 200 is 0V, a level of the predetermined default voltage is not limited by the first reference voltage or the second reference voltage. In other words, the predetermined default voltage may be determined as a voltage of low level (for example, 3-5V), which can form an electric potential difference to allow the electric current to flow into the relay apparatus 200 from the voltage regulator 130. In some cases, the predetermined default voltage may be also determined as any one of 13V and 18V, which correspond to the first reference voltage and the second reference voltage, respectively.

The current check block 134 of the voltage regulator 130 may detect the electric current flowing through the connector 110 as above, and the controller 190 may determine that the antenna 210 is connected to the connector 110 of the broadcast signal receiving apparatus 100 according to the detection result of the current check block 134.

If the connection of the antenna 210 is checked in any one method of the exemplary embodiments 1 to 3 as described above, the controller 190 resets the DC voltage value of the voltage regulator 130 to 0V. And, the set voltage value of the voltage regulator 130 is maintained to 0V, and then may be adjusted to 13V or 18V according to a channel selection of the user.

According to the exemplary embodiments as described above, the broadcast signal receiving apparatus 100 may automatically check whether the antenna 210 is connected by a simple method, which sets the DC voltage value of the voltage regulator 130, e.g., the LNB IC, to the predetermined default value and detects the electric current of flowing according thereto. Thus, even if the user does not manually check the connection of the antenna or perform manually the setting for the satellite broadcast signal, it is possible for the broadcast signal receiving apparatus to automatically perform it. By the setting for the satellite broadcast signal as described above, the controller 190 may automatically switch an image source from the outside, i.e., a main source, to the antenna 210.

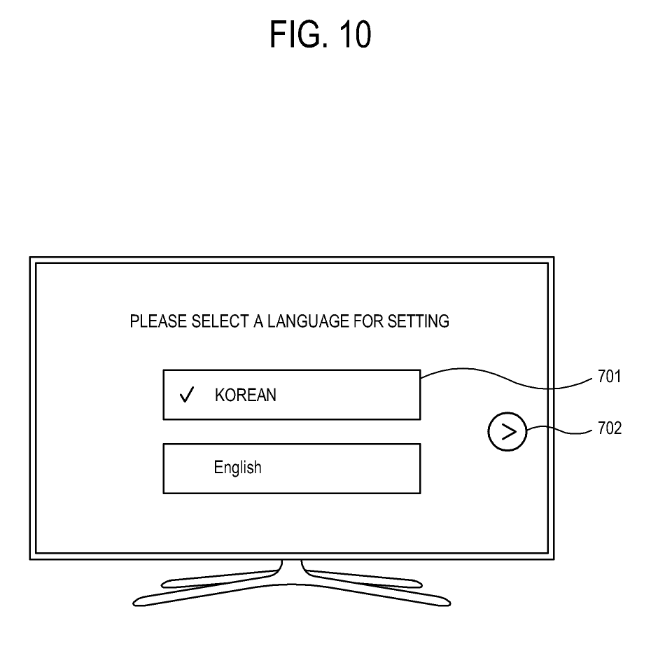

Although the automatic check of the antenna connection by the electric current detection as described above is explained as being performed at initial power up of the broadcast signal receiving apparatus 100, the timing of the automatic check is not limited thereto. For instance, the automatic check of the antenna connection may be performed when the relay apparatus 200 including the antenna 210 or the connection cable is reconnected due to failures or troubles thereof. Further, the automatic check of the antenna connection may be periodically performed. Also, in response to a predetermined event occurrence, for example, a reception of user input for initial setting with respect to the broadcast signal receiving apparatus 100 from the user as in FIG. 10 to be described later, the controller 160 may check whether the antenna 210 is connected by outputting the I2C control signal to the voltage regulator 130 and detecting the electric current.

The user may confirm through a screen that the connection between the antenna 210 and the broadcast signal receiving apparatus 100 is automatically checked.

FIG. 9 is a view illustrating a screen, which displays whether the antenna 210 is connected, at the broadcast signal receiving apparatus 100 according to an exemplary embodiment.

To be more specific, if user's manipulation through the user input interface 160 (e.g., the external input button 161 provided on the remote control) is detected, the controller 190 may control the display 150 to display currently connected sources, as illustrated in FIG. 9.

Here, the user may manipulates the external input button 161 any time regardless of the settings for the broadcast signal, and the automatic check results with respect to connection of the antenna 200 are displayed on the screen, as illustrated in FIG. 9.

FIG. 9 illustrates by way of example when the broadcast signal is receivable via a terrestrial cable, a HDMI terminal 1 and a cable for satellite antenna 210. In FIG. 9, items 601, 602, and 604 corresponding to currently connected sources are displayed in an activated state. In FIG. 9, items corresponding to unconnected sources, for example, an item 603 corresponding to a HDMI terminal 2, are displayed in a non-activated state.

In response to the manipulation on the external input button 161 from the user, the controller 190 may control the display 150 to further display on the screen of FIG. 9, a message for guiding a connection with a specific source (for example, a satellite antenna), which is not currently connected.

In an exemplary embodiment, on determining that the antenna 210 capable of receiving the satellite broadcast signal is connected to the broadcast signal receiving apparatus 100 using the automatic connection checking method as described above, the controller 190 may perform a setting for the broadcast signal received from the antenna 210. Here, the setting for the broadcast signal includes, but is not limited to, an auto scan, i.e., an automatic channel tuning for the broadcast signal.

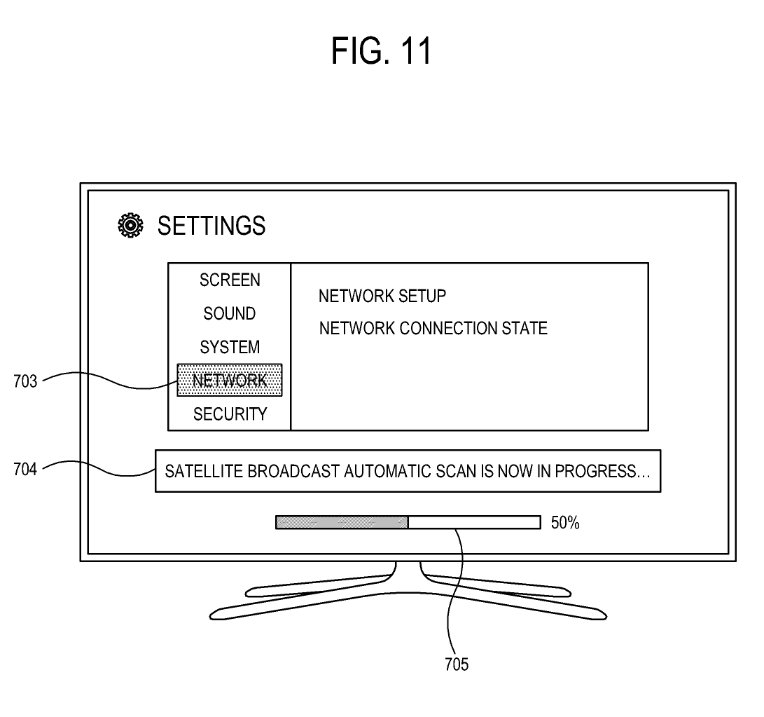

FIGS. 10 and 11 are views illustrating screens for setting the broadcast signal at the broadcast signal receiving apparatus 100 according to an exemplary embodiment.

If it is determined that the satellite antenna 210 is connected to the connector 110 to enable the reception of the broadcast signal, the controller 190 may control the display 150 to display, for example, a screen of enabling a selection for language setting, as an initial screen for performing the setting for the received broadcast signal, as illustrated in FIG. 10.

The user may select an item 701 corresponding to any one from among a plurality of languages (For example, Korean and English) displayed on the initial screen. FIG. 10 illustrates when Korean is selected.

The user may select a ‘next’ item 702 at the initial screen of FIG. 10 to continue the settings. As illustrated in FIG. 11, the user may select, for example, a network item 703 to perform a network setting.

Here, the controller 190 may perform the auto scan (hereinafter, also referred to an automatic scan, an automatic channel tuning, an automatic channel setting, or an automatic channel scan) for channels receivable via the satellite antenna 210 as the setting for the broadcast signal, regardless of the settings of the user as illustrated in FIG. 10 or 11.

In an exemplary embodiment, if it is determined that the satellite antenna 210 is connected as the electric current flowing through the connector 110 is detected, the controller 190 may immediately perform the automatic channel tuning for channels receivable from the antenna 210.

In another exemplary embodiment, if it is determined that the satellite antenna 210 is connected as the electric current flowing through the connector 110 is detected, the controller 190 may first control the display 150 to display the initial setting screen as illustrated in FIG. 10, and then if the language selection is completed at the initial setting screen, may perform the automatic channel tuning for channels receivable from the antenna 210.

The controller 190 may display the results of the automatic channel tuning, which is performed in response to the detection of the connection of the antenna 210, via the display 150. For instance, while a screen for network setting as illustrated in FIG. 11 is displayed, a message 704, which indicates that the auto scan for satellite broadcast channels is now in progress, may displayed in an region of the display 130. Also, a progress bar 705, which indicates a progress of the auto scan, may be further displayed on the display 150.

Since FIG. 11 illustrates by way of example the network setting screen as an exemplary embodiment of displaying a screen irrelevant to the automatic channel tuning, examples of the display screen according to the present disclosure are not limited thereto. For instance, if the controller 190 detects a connection of the satellite antenna 190 while the user watches a broadcast of a terrestrial channel, it may display a message and/or a progress bar 705, which indicates that an automatic channel tuning for satellite broadcast is in progress, while an image of the terrestrial channel is displayed.

If the automatic channel tuning for satellite broadcast is completed, the controller 190 may store result information and display a message indicating that the automatic channel tuning is completed, via the display 150.

Hereinafter, a control method of the broadcast signal receiving apparatus 100 according to an exemplary embodiment will be described with reference to the drawings.

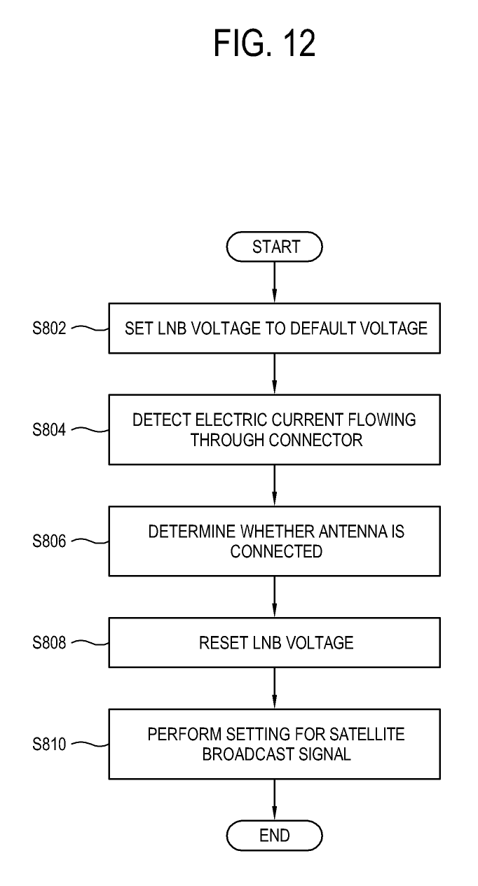

FIG. 12 is a flowchart illustrating a control method of the broadcast signal receiving apparatus according to an exemplary embodiment.

As illustrated in FIG. 12, the controller 190 may output an I2C control signal to the voltage regulator 130 to set a LNB voltage (DC output voltage) of the voltage regulator 130 to a predetermined default voltage (S802). Here, the predetermined default voltage may be set to have a level higher than a second reference voltage (18V), which is a high voltage from among LNB reference voltages that are supplied to the relay apparatus 200 to receive a broadcast signal according to a channel selection. Alternatively, the predetermined default voltage may be set to have a level lower than a first reference voltage (13V), which is a low voltage from among the LNB reference voltages.

The voltage regulator 130 may check if an electric current flowing through the connector 110 in real time (S804). Here, an electric potential difference is generated between the relay apparatus 200 and the voltage regulator 130 according to the voltage setting at the operation S802, and an electric current according to the electric potential difference flows the connector 110. The voltage regulator 130 may detect the electric current flowing through the connector 110 with the current check block 134.

The controller 190 may determine whether the antenna 210 is connected, based on the current checking result at the operation S804 (S806). Here, if it is detected that an electric current equal to or greater than a predetermined reference current flows, the controller may determine that the connector 110 is connected with the relay apparatus 200 including the antenna 210. The predetermined reference current may be set taking account of a minute electric current that flows irrespective of the connection or non-connection of the antenna 210.

The controller 190 reset the LNB voltage, which was set to the default voltage at the operation S802, to 0 (S808).

If it is determined that the antenna 210 is connected at the operation S806, the controller 190 may perform a setting for a satellite broadcast signal received from the antenna 210 (S810). Here, the setting for the satellite broadcast signal may include, but is not limited to, an automatic channel tuning for the satellite broadcast signal, i.e., an auto scan. In this process, a source that supplies a broadcast signal to the broadcast signal receiving apparatus 100, i.e., a main source, may be changed by switching to the satellite antenna 210.

According to various exemplary embodiments as described above, it may be determined whether the broadcast signal receiving apparatus 100 is connected with the antenna 210 in a simple manner by setting the output voltage of the voltage regulator 130 (e.g., the LNB IC) to the default voltage of predetermined level and detecting the electric current of flowing through an input side of the tuner 120, i.e., the connector 110, in real time.

Here, the default voltage may be determined taking account of the first and the second reference voltages that are applied to the relay apparatus 200 according to the channel selection, so that the connection or non-connection of the antenna 201 may be simply checked not only when the antenna 201 is connected to a single broadcast signal receiving apparatus 100, but also when one antenna is shared with a plurality of broadcast signal receiving apparatuses.

Also, without manipulation of the user, the connection or non-connection of the antenna 201 may be automatically determined and even the setting for the broadcast signal including the automatic channel tuning may be automatically performed, thereby providing a more enhanced user convenience.

Meanwhile, the various exemplary embodiments as described above may be implemented as a computer-readable program and/or a recording medium in which the computer-readable program is recorded. The recording medium include a non-transitory storing medium. The program may be transmitted and received via transmission media, which is implemented through a wired and wireless network in which computer systems are interconnected.

The various exemplary embodiments may be implemented by a hardware, a software and/or a combination thereof.

As the hardware, the controller 190 may include a non-volatile memory in which a computer program of software is stored, a RAM in which the computer program stored in the non-volatile memory is loaded, and a CPU which executes the computer program loaded in the RAM. The non-volatile memory includes a hard disc drive, a flash memory, a ROM, CD-ROMs, a magnetic tape, a floppy disc, an optical storage, a data transmission device using an internet, etc. and is not limited thereto. The non-volatile memory is an example of the computer-readable recording medium in which the computer-readable program according to the present disclosure is recoded.

The computer program as codes readable and executable by the CPU and the processor including the IC includes codes, which includes the operations S802 to S810 as illustrated in FIG. 12 to allow the controller 190 and/or the voltage regulator 130 to operate the operations.

The computer program may be implemented as being incorporated in a software including then operating system or applications provided in the broadcast signal receiving apparatus 100 and/or a software interfacing with the external apparatus.

While the exemplary embodiments have been shown and described with reference to various embodiments thereof, it will be understood by those skilled in the art that various changes in form and details may be made therein without departing from the present disclosure as defined by the appended claims and their equivalents.

What is claimed is:

1. A broadcast signal receiving apparatus comprising:
a connector configured to connect the broadcast signal receiving apparatus to an antenna;
a tuner configured to output a control signal to the antenna via the connector such that the antenna tunes a broadcast signal based on the control signal;
a voltage regulator configured to supply a voltage of a predetermined level to the antenna via the connector, and detect an electric current flowing through the connector; and
at least one processor configured to:
control the voltage regulator to adjust the control signal outputted by the tuner based on a channel selection for the broadcast signal, and
in response to the electric current flowing through the connector being detected by the voltage regulator, determine that the antenna is connected to the connector and perform a setting for the broadcast signal.

2. The apparatus according to claim 1, wherein the at least one processor is further configured to set an output voltage of the voltage regulator to a predetermined default voltage,
wherein the voltage regulator is further configured to detect the electric current flowing through the connector in response to the predetermined default voltage being set, and
wherein the predetermined default voltage is determined based on a first reference voltage or a second reference voltage, the first reference voltage and the second reference voltage being output voltages of the voltage regulator generated based on the channel selection.

3. The apparatus according to claim 2, wherein the second reference voltage has a level higher than the first reference voltage, and the predetermined default voltage has a level higher than the second reference voltage.

4. The apparatus according to claim 2, wherein the second reference voltage has a level higher than the first reference voltage, and the predetermined default voltage has a level higher than 0 and lower than the first reference voltage.

5. The apparatus according to claim 1, wherein the at least one processor is further configured to, in response to the electric current flowing through the connector being not detected by the voltage regulator, set an output voltage of the voltage regulator to a predetermined default voltage, and
wherein the voltage regulator is configured to, in response to the predetermined default voltage being set, detect the electric current flowing through the connector.

6. The apparatus according to claim 1, wherein the voltage regulator is further configured to detect if an electric current equal to or greater than a predetermined reference current flows through the connector.

7. The apparatus according to claim 1, wherein the at least one processor is further configured to, in response to determining that the antenna is connected to the connector, reset an output voltage of the voltage regulator to 0.

8. The apparatus according to claim 1, wherein the at least one processor is further configured to, in response to determining that the antenna is connected to the connector, perform an automatic channel tuning for the broadcast signal received through the antenna.

9. The apparatus according to claim 1, wherein the at least one processor is further configured to, in response to determining that the antenna is connected to the connector, change an image source for the broadcast signal receiving apparatus to the antenna.

10. The apparatus according to claim 1, further comprising:
a display; and
a user input interface,
wherein the at least one processor is further configured to, in response to an external input button provided in the user input interface being selected, control the display to display the antenna as a connected external input.

11. A method of controlling a broadcast signal receiving apparatus to receive a broadcast signal from an antenna, comprising:
setting an output voltage of a voltage regulator to a predetermined default voltage, the voltage regulator being configured to supply a voltage of a predetermined level to the antenna via a connector to which the antenna is connectable;
in response to the predetermined default voltage being set, detecting an electric current flowing through the connector; and
in response to the electric current flowing through the connector being detected, determining that the antenna is connected to the connector and performing a setting for the broadcast signal received from the antenna.

12. The method according to claim 11, wherein the predetermined default voltage is determined based on a first reference voltage or a second reference voltage, the first reference voltage and the second reference voltage being output voltages of the voltage regulator generated based on a channel selection for the broadcast signal.

13. The method according to claim 12, wherein the second reference voltage has a level higher than the first reference voltage, and the predetermined default voltage has a level higher than the second reference voltage.

14. The method according to claim 12, wherein the second reference voltage has a level higher than the first reference voltage, and the predetermined default voltage has a level higher than 0 and lower than the first reference voltage.

15. The method according to claim 11,
wherein the setting of the output voltage of the voltage regulator comprises, in response to the electric current flowing through the connector being not detected, setting the output voltage of the voltage regulator to the predetermined default voltage.

16. The method according to claim 11, wherein the detecting of the electric current flowing through the connector comprises detecting if an electric current equal to or greater than a predetermined reference current flows through the connector.

17. The method according to claim 11, further comprising:
in response to determining that the antenna is connected to the connector, resetting the output voltage of the voltage regulator to 0.

18. The method according to claim 11, further comprising:
in response to determining that the antenna is connected to the connector, performing an automatic channel tuning for the broadcast signal received through the antenna.

19. The method according to claim 11, further comprising:
in response to determining that the antenna is connected to the connector, changing an image source for the broadcast signal receiving apparatus to the antenna.

20. The method according to claim 11, further comprising:
receiving a selection input for an external input button provided in a user input interface; and
in response to the selection input for the external input button, displaying the antenna as a connected external input.
